(19) United States
(12) Patent Application Publication
(10) Pub. No.: US 2013/0328821 A1
(43) Pub. Date: Dec. 12, 2013

(54) SYSTEM AND METHOD FOR GRADIENT IMAGING SENSORS

(71) Applicant: Mihai Bulea, Santa Clara, CA (US)

(72) Inventor: Mihai Bulea, Santa Clara, CA (US)

(73) Assignee: SYNAPTICS INCORPORATED, Santa Clara, CA (US)

(21) Appl. No.: 13/489,774

(22) Filed: Jun. 6, 2012

(51) Int. Cl. G06F 3/044

(52) U.S. Cl. 345/174

(57) ABSTRACT

A processing system for an input device includes a transmitter module, a receiver module, and a determination module. The transmitter module, which includes transmitter circuitry, is coupled to a plurality of transmitter electrodes and configured to drive a first end of a first transmitter electrode of the plurality of transmitter electrodes to produce a first voltage gradient across the first transmitter electrode. The receiver module is configured to receive a plurality of resulting signals with a plurality of receiver electrodes, the plurality of resulting signals each comprising effects of the first voltage gradient. The determination module is configured to determine a two-dimensional capacitive image based on the plurality of resulting signals, and determine positional information for a first input object located within a sensing region based on the capacitive image.

### FIELD OF THE INVENTION

This invention generally relates to electronic devices, and more specifically relates to sensor devices.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers).

Gradient sensors are sensors that employ a voltage variation across one or more electrodes (usually a transmitter electrode) to assist in determining positional information. There is a need for systems and methods capable of implementing image-type sensors utilizing gradient sensor technology.

### BRIEF SUMMARY OF THE INVENTION

A processing system for an input device in accordance with one embodiment of the invention includes a transmitter module, a receiver module, and a determination module. The transmitter module, which comprises transmitter circuitry, is coupled to a plurality of transmitter electrodes and configured to drive a first end of a first transmitter electrode of the plurality of transmitter electrodes to produce a first voltage gradient across the first transmitter electrode. The receiver module is configured to receive a plurality of resulting signals with a plurality of receiver electrodes, the plurality of resulting signals each comprising effects of the first voltage gradient. The determination module is configured to determine a two-dimensional capacitive image based on the plurality of resulting signals, and determine positional information for a first input object located within a sensing region based on the capacitive image.

An image gradient sensor device in accordance with one embodiment includes a plurality of transmitter electrodes, a plurality of receiver electrodes, and a processing system communicatively coupled to the plurality of transmitter electrodes and the plurality of receiver electrodes. The processing system is configured to drive a first end of a first transmitter electrode to produce a first voltage gradient across the first transmitter electrode, receive a plurality of resulting signals with the plurality of receiver electrodes, the plurality of resulting signals each comprising effects of the first voltage gradient, and determine a two-dimensional capacitive image based on the plurality of resulting signals, and determine positional information for a first input object located within a sensing region based on the capacitive image.

A method of capacitive sensing in accordance with one embodiment comprises: driving a first end of a first transmitter electrode to produce a first voltage gradient across the first transmitter electrode; receiving a plurality of resulting signals with the plurality of receiver electrodes to produce a two-dimensional capacitive image, the plurality of resulting signals each comprising effects of the first voltage gradient; and determining positional information for a first input object located within a sensing region based on the capacitive image.

### BRIEF DESCRIPTION OF DRAWINGS

The present invention will hereinafter be described in conjunction with the appended drawings, where like designations denote like elements, and:

FIG. 1 is a block diagram of an example system that includes an input device in accordance with an embodiment of the invention;

FIG. 2A is a conceptual block diagram depicting an example electrode pattern;

FIG. 2B is a conceptual block diagram depicting an example electrode pattern;

FIG. 2C is a conceptual block diagram depicting an example electrode pattern;

FIG. 3 is a conceptual diagram depicting an example processing system in accordance with the present invention;

FIG. 4 is a conceptual block diagram depicting an example electrode pattern; and

FIG. 5 is a conceptual block diagram depicting an example electrode pattern.

### DETAILED DESCRIPTION OF THE INVENTION

The following detailed description presents a number of example embodiments and is not intended to limit the invention or the application and uses of the invention. Furthermore, there is no intention to be bound by any expressed or implied theory presented in the preceding technical field, background, brief summary, or the following detailed description.

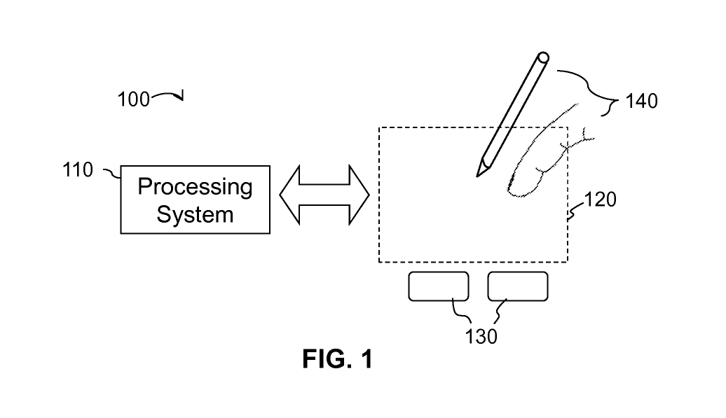

Various embodiments of the present invention provide input devices and methods that facilitate improved usability. FIG. 1 is a block diagram of an example input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be substantially uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

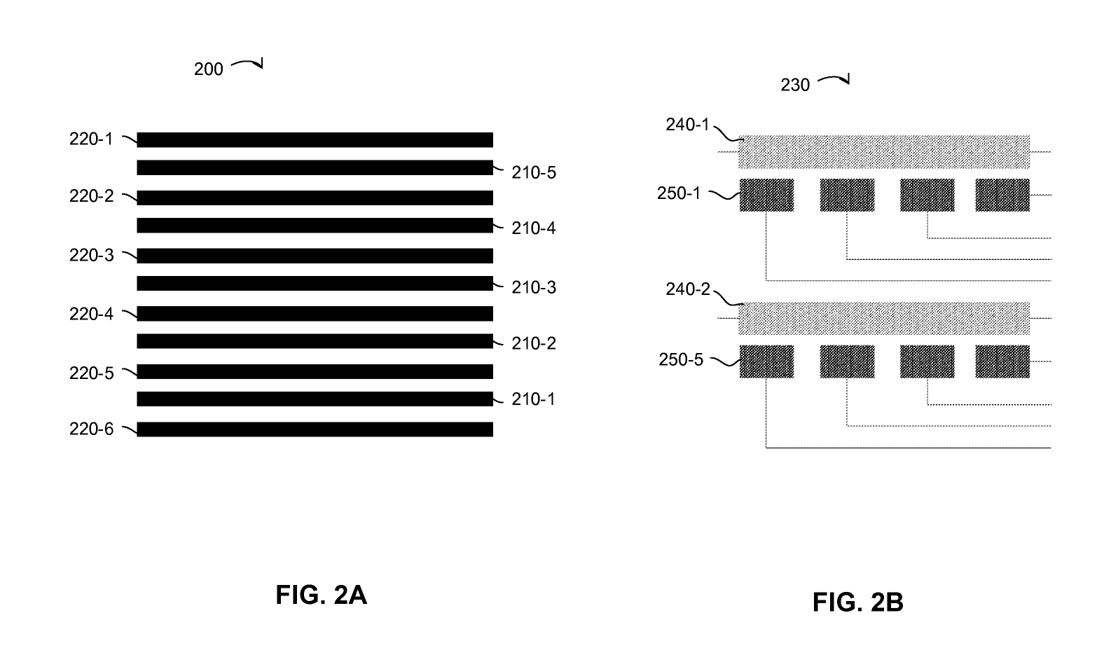

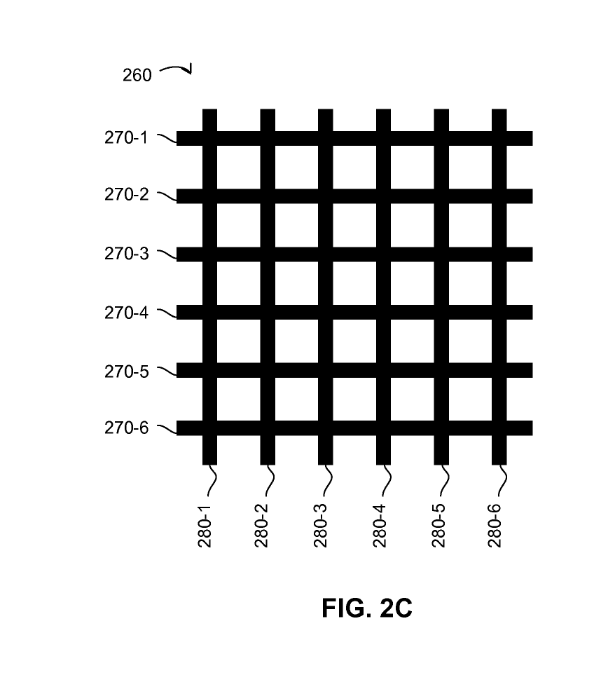

FIGS. 2A-C illustrate, conceptually, example sets of capacitive sensor electrodes configured to sense in a sensing region. For clarity of illustration and description, FIGS. 2A and 2B show patterns of sensor electrodes arranged substantially parallel to each other, while FIG. 2C shows a pattern of sensor electrodes arranged substantially perpendicular to each other. FIGS. 2A-C illustrate different forms of what may be referred to as “gradient” sensor electrodes, in which a voltage variation is produced in the electrodes, as described in further detail below. The embodiments illustrated in FIGS. 2B and 2C may further be referred to as electrodes for an “imaging” sensor, or a “gradient imaging sensor.” The term “gradient sensor” is thus used herein, without loss of generality, to refer to a sensor device employing one or more such voltage variations as described herein. It will be appreciated, however, that the invention is not so limited, and that a variety of electrode patterns and shapes may be suitable in any particular embodiment.

The sensor electrodes of FIGS. 2A-C are typically ohmically isolated from each other. According to various embodiments, the sensor electrodes can be located in a single layer or can be separated by one or more substrates. For example, they may be disposed on opposite sides of the same substrate, or on different substrates that are laminated together.

The capacitive coupling between the transmitter electrodes and receiver electrodes change with the proximity and motion of input objects in the sensing region associated with the transmitter electrodes and receiver electrodes. In the embodiment depicted in FIG. 2A, some sensor electrodes 210 (e.g., 210-1, 210-2, etc.) are configured as receiver electrodes, and some sensor electrodes 220 (e.g., 220-1, 220-2, etc.) are configured as transmitter electrodes. In an embodiment depicted in FIG. 2B, some sensor electrodes 250 (e.g., 250-1, 250-2, etc.) are configured as receiver electrodes, and some sensor electrodes 240 (e.g., 240-1, 240-2, etc.) are configured as transmitter electrodes. In addition, in an embodiment depicted in FIG. 2C, some sensor electrodes 270 (e.g., 270-1, 270-2, etc.) are configured as receiver electrodes, and some sensor electrodes 280 (e.g., 280-1, 280-2, etc.) are configured as transmitter electrodes.

In each of the illustrated embodiments (as well as other example embodiments) the receiver sensor electrodes may be operated singly or multiply to acquire resulting signals. The resulting signals may be used to determine a “capacitive frame” representative of measurements of the capacitive couplings. Multiple capacitive frames may be acquired over multiple time periods, and differences between them used to derive information about input in the sensing region. For example, successive capacitive frames acquired over successive periods of time can be used to track the motion(s) of one or more input objects entering, exiting, and within the sensing region.

Referring again to FIG. 1, a processing system 110 is shown as part of the input device 100. The processing system 110 is configured to operate the hardware of the input device 100 (including, for example, the various sensor electrodes in FIGS. 2A-C) to detect input in the sensing region 120. The processing system 110 comprises parts of or all of one or more integrated circuits (ICs) and/or other circuitry components. For example, as described in further detail below, a processing system for a mutual capacitance sensor device may comprise transmitter circuitry configured to transmit signals with transmitter sensor electrodes, and/or receiver circuitry configured to receive signals with receiver sensor electrodes).

In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like. In one embodiment, processing system 110 includes determination circuitry configured to determine positional information for an input device based on the measurement.

“Positional information” as used herein broadly encompasses absolute position, relative position, velocity, acceleration, and other types of spatial information. Example “zero-dimensional” positional information includes near/far or contact/no contact information. Example “one-dimensional” positional information includes positions along an axis. Example “two-dimensional” positional information includes motions in a plane. Example “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

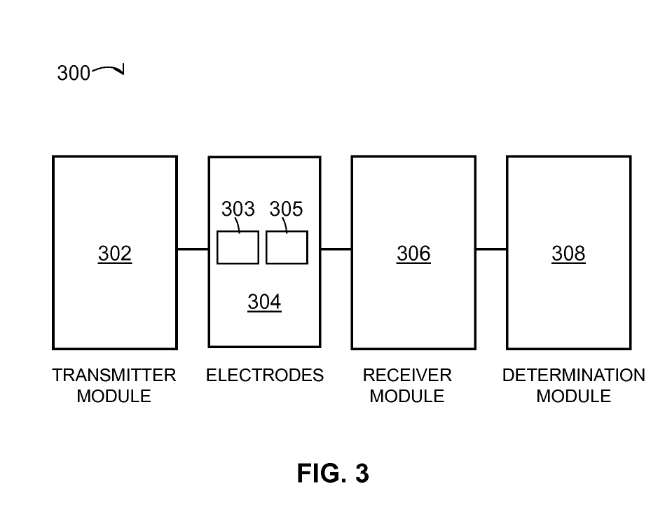

Referring now to the conceptual block diagram depicted in FIG. 3, various embodiments of an example processing system 110 as shown in FIG. 1 may include a system 300. System 300, as illustrated, generally includes transmitter module 302 communicatively coupled via a set of sensor electrodes 304 to receiver module 306, which itself is coupled to determination module 308. Sensor electrodes 304 include one or more transmitter electrodes 303 and one or more receiver electrodes 305. In one embodiment, sensor electrodes 304 may be constructed from opaque or substantially opaque conductive materials. In other embodiments sensor electrodes 304 can be constructed from transparent or substantially transparent conductive material, such as patterned ITO, ATO, carbon fiber nanotubes, or other substantially transparent materials. In one embodiment, transmitter electrodes 303 are constructed from a conductive material of substantially uniform resistivity, so that voltage variations can be imposed on it by the driving methods described below. In some embodiments, the conductive material may have non-uniform resistivity, such as having a higher or lower resistivity on the distal ends than in the middle portion. Other forms of non-uniform resistivity can also be implemented. In one embodiment, the voltage variations may be defined as the amount of change in voltage as a function of a small change in position along a transmitter electrode comprising resistive material. In practical embodiments, sensor electrodes 304 may be accompanied by (and coupled to) various conductive traces, electro-mechanical bonds, and the like (not shown).

In general, transmitter module 302 includes any combination of software and/or hardware (e.g., transmitter circuitry) configured to drive one or more transmitter electrodes to produce respective voltage gradients across those transmitter electrodes.

Receiver module 306 includes any combination of software and/or hardware (e.g., receiver circuitry) configured to receive a plurality of resulting signals, each comprising effects of the respective voltage gradients produced across the transmitter electrodes.

Determination module 308 includes any combination of software and/or hardware (e.g., circuitry) configured to determine a two-dimensional capacitive image based on the plurality of resulting signals, and to determine positional information for one or more input objects (e.g., two input objects) within a sensing region based on the capacitive image.

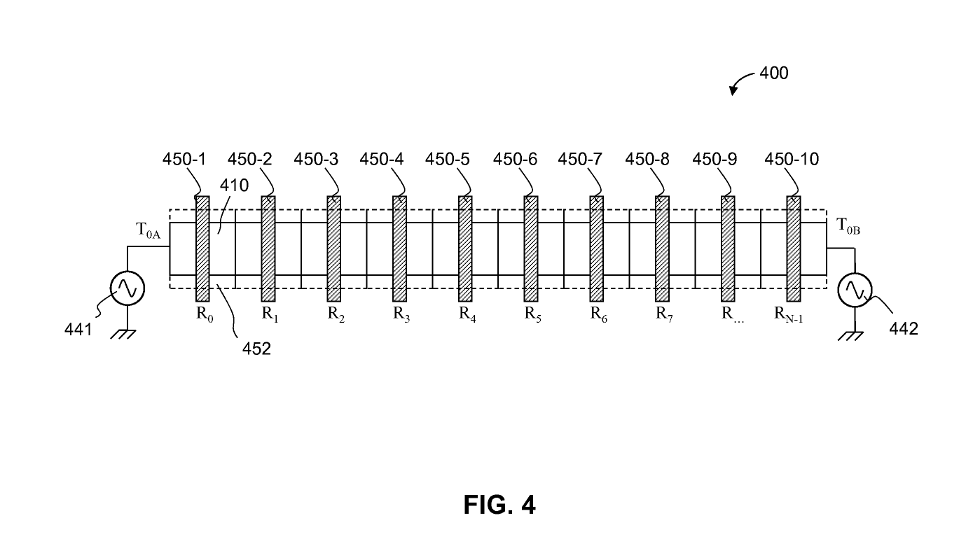

FIG. 4 depicts, in simplified form, an example electrode pattern along with a portion of its associated transmitter circuitry. In this embodiment, drive signals (T0A and T0B) are applied across a transmitter electrode 410 by transmitters 441 and 442, which are communicatively coupled to opposite ends of transmitter electrode 410. Transmitters 441 and 442 together act to produce a voltage gradient across transmitter electrode 410, and may comprise any combination of hardware and software configured to apply drive signals as described herein.

In this regard, “applying” a drive signal across transmitter electrode 410 refers to driving (e.g., simultaneously) on one or more ends of transmitter electrodes 410 by imparting or otherwise causing a series of bursts, pulses or voltage transitions for a period of time. For example, one end of transmitter electrode 410 may be driven with a substantially constant voltage (e.g., system ground or any other substantially constant voltage) while the opposite end is driven with a particular drive signal. According to various embodiments, the drive signals may be substantially constant, varying, codes, orthogonal frequency multiplexed, or time division multiplexed.

In one embodiment, two or more of the drive signals are “mathematically independent,” that is, the signals are selected such that they provide meaningful independent results. For example, drive signals may exhibit zero or low cross-correlation. That is, drive signals may be considered “mathematically independent” even if the cross-correlation of the signals is not strictly zero, as long as the signals provide meaningful independent results. In one embodiment, the mathematically independent drive signals are orthogonal to each other. In other embodiments, the mathematically independent drive signals are substantially orthogonal to each other. In some embodiments, the drive signals are mathematically independent in phase, as might be implemented in phase modulation (PM) systems. In some embodiments, the drive signals are mathematically independent in frequency. Examples include various frequency modulation (FM) schemes, such as orthogonal frequency-division-multiplexing (OFDM). In other embodiments, the drive signals are mathematically independent in code. In one embodiment, code divisional multiple access (CDMA) is implemented. In one embodiment, for example, the drive signals are pseudo-random sequence codes. In other embodiments, Walsh-Hadamard codes, m-sequence codes, Gold codes, Kasami codes, Barker codes, or other appropriate quasi-orthogonal or orthogonal codes are used.

Transmitter electrode 410 may have a substantially uniform thickness and width along its length, but have a non-uniform resistivity due to the nature of the transmitter electrode itself. That is, transmitter electrode 410 may be a substantially uniform resistive material, non-uniform resistive material, or may include geometrical features (narrow cross-sectional regions, or the like) that give rise to various shapes and amplitudes of voltage gradients. Transmitter electrode 410 may also include a mixture of materials having differing sheet resistivities, such that the weight percentage of the materials varies in a known way across the length of the transmitter electrode. The resulting voltage variations may be linear, non-linear, piecewise linear, smooth (differentiable), non-smooth, or characterized by any other desired mathematical function.

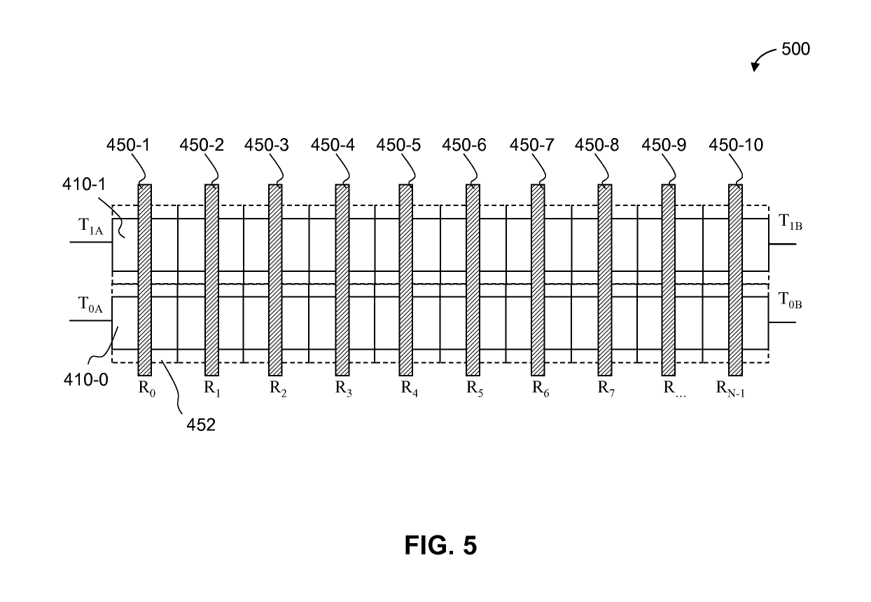

With continued reference to FIG. 4, a plurality of receiver electrodes 450 (e.g., 450-1, 450-2, etc.) are provided adjacent to or otherwise situated with respect to transmitter electrode 410. As mentioned previously, receiver electrodes 450 work in connection with an associated receiver module (e.g., receiver module 306 of FIG. 3) to receive a plurality of resulting signals, each comprising effects of the voltage gradient produced across transmitter electrode 410 via transmitters 441 and 442. Thus, a series of “pixels” 452 of a capacitive image are defined (indicated, in simplified form, by dotted rectangular regions in FIGS. 4 and 5) at the intersections of transmitter electrode 410 and receiver electrodes 450. In this way, a determination module (e.g., determination module 308 of FIG. 3) may determine a capacitive image based on the plurality of resulting signals. That is, the position of one or more input objects laterally along transmitter electrode 410 may be determined based on the local change in capacitance induced by the proximity of the input object(s), since at any particular time the nature of the voltage gradient across transmitter electrode 410 is known.

In the illustrated embodiment, receiver electrodes 450 are distributed at regular intervals; however the invention is not so limited. Furthermore, while only ten receiver electrodes 450 are illustrated, any number of such receiver electrodes may be used. Receiver electrodes 450 may also be referred to herein as R0-RN−1 (with N being the total number of receiver electrodes). Furthermore, while the embodiment depicted in FIG. 4 is associated with a “one-dimensional” capacitive image (i.e., a series of pixels distributed along a line segment), the present invention contemplates two-dimensional capacitive images including any number of transmitter electrodes 410.

FIG. 5 depicts an example electrode pattern 500 including two transmitter electrodes 410 (410-0 and 410-1) disposed substantially parallel to one other. Thus, the electrode pattern 500 is associated with a two-dimensional capacitive image (i.e., a 2×10 array of pixels). As with the embodiment shown in FIG. 4, in this embodiment drive signals T_{0A}, and T_{0B} are applied across transmitter electrode 410-0 by transmitters (not shown) communicatively coupled to opposite ends of transmitter electrode 410-0, while drive signals T_{1A} and T_{1B} are similarly applied across transmitter electrode 410-1. As a result, corresponding voltage gradients may be produced (e.g., simultaneously) across transmitter electrodes 410-0 and 410-1. Determination module 308 may then determine the two-dimensional capacitive image based on both a first plurality of resulting signals (associated with transmitter electrode 410-0) and second plurality of resulting signals (associated with transmitter electrode 410-1).

As with transmitter electrode 410 of FIG. 4, transmitter electrodes 410-0 and 410-1 may each be a substantially uniform resistive material, a non-uniform resistive material, or may include geometrical features (narrow cross-sectional regions, or the like) that give rise to various shapes and amplitudes of voltage gradients.

In accordance with one embodiment, one of the plurality of resulting signals received by the receiver module (e.g., receiver module 306 of FIG. 3) is substantially an interference-related resulting signal. With continued reference to FIG. 5, for example, one of the receiver electrodes 450 (e.g., a leftmost receiver electrode 450-1 or rightmost receiver electrode 450-10) may produce a resulting signal whose characteristics can be examined to measure, infer, or otherwise determine the extent to which some form of interference is affecting the determination of positional information.

For example, the electrode pattern depicted in FIG. 5 might exhibit a form of “row-to-row” noise. That is, the noise affecting the electrode pattern 500 may be the same (spatially uniform) at a particular time but vary over time. This so called “unison noise” can be caused, for example, by an LCD component disposed underneath the sensing region. As a result of unison noise, the resulting signals measured for each row may vary if the rows are read at different times (e.g., sequentially). However, by using the interference-related signal it is possible to minimize the effects of row-to-row noise. In the discussion that follows, the word “row” may be used to refer to resulting signals or measurements associated with a particular transmitter electrode 410, while the word “column” is used to refer to resulting signals or measurements associated with a particular receiver 450.

In general, in accordance with one embodiment, a drive signal is applied to a first end of each transmitter electrode 410 (e.g., T_{1A}) while a second end is grounded (e.g., T_{1B}). Subsequently, a drive signal is applied to the second end of each transmitter electrode 410 while the first end is grounded. Since the voltage of the voltage gradient is substantially zero near the grounded end of the transmitter, the resulting signal received by the receiver closest to the grounded end (e.g., 450-1 or 450-10) should be substantially zero. Therefore, any signal received by the receiver closest to the grounded end is substantially a measurement of noise (i.e., an interference-related resulting signal).

In one embodiment, each transmitter is driven to produce two different voltage gradients and a set of resulting signals is captured. As a result, N values can be read for each row, where N is the number of pixels in a row. Specifically, let Pᵢ be a capacitive (e.g., trans-capacitive) measurement for a given pixel i. The two profiles (A=[a₀, a₁, . . . , a_{N-1}], B=[b₀, b₁, . . . , b_{N-1}]) are then given by:

$$\{ \begin{matrix}{a}_{0} = {k}_{0} {P}_{0} \\ {a}_{1} = {k}_{1} {P}_{1} \\ {a}_{2} = {k}_{2} {P}_{2} \\ … \\ {a}_{N - 1} = {k}_{N - 1} {P}_{N - 1}\end{matrix} \\ and then \\ \{ \begin{matrix}{b}_{0} = ( 1 - {k}_{0} ) {P}_{0} \\ {b}_{1} = ( 1 - {k}_{1} ) {P}_{1} \\ {b}_{2} = ( 1 - {k}_{2} ) {P}_{2} \\ … \\ {b}_{N - 1} = ( 1 - {k}_{N - 1} ) {P}_{N - 1}\end{matrix} \qquad ( 1 )$$

where (for uniform spacing and constant resistivity) the values kᵢ are constants extracted from the geometry of the sensor, and define the fraction of the pixel value read for first excitation (e.g., ground the left end of a transmitter, and apply a drive signal to the right end), such that:

kᵢ=(i+0.5)/N, i=0 . . . N−1 (2)

By adding the two resulting signals in (1), the result is:

$$\{ \begin{matrix}{a}_{0} + {b}_{0} = {P}_{0} \\ {a}_{1} + {b}_{1} = {P}_{1} \\ {a}_{2} + {b}_{2} = {P}_{2} \\ … \\ {a}_{N - 1} + {b}_{N - 1} = {P}_{N - 1}\end{matrix} \qquad ( 3 )$$

In the presence of unison noise, however, the system will in fact read the following excitations:

$$\{ \begin{matrix}{\tilde{a}}_{0} = {k}_{0} {P}_{0} + α \\ {\tilde{a}}_{1} = {k}_{1} {P}_{1} + α \\ {\tilde{a}}_{2} = {k}_{2} {P}_{2} + α \\ … \\ {\tilde{a}}_{N - 1} = {k}_{N - 1} {P}_{N - 1} + α\end{matrix} \\ and \\ \{ \begin{matrix}{\tilde{b}}_{0} = ( 1 - {k}_{0} ) {P}_{0} + β \\ {\tilde{b}}_{1} = ( 1 - {k}_{1} ) {P}_{1} + β \\ {\tilde{b}}_{2} = ( 1 - {k}_{2} ) {P}_{2} + β \\ … \\ {\tilde{b}}_{N - 1} = ( 1 - {k}_{N - 1} ) {P}_{N - 1} + β\end{matrix} \qquad ( 4 )$$

where α and β are offset values. In equation 4, there are 2N equations and N+2 unknowns. Minimizing the error, E, gives:

$$E = \frac{1}{N} {\sum }_{i = 0}^{N - 1} {[ {k}_{i} {P}_{i} + α - {\tilde{a}}_{i} ]}^{2} + \frac{1}{N} {\sum }_{i = 0}^{N - 1} {[ ( 1 - {k}_{i} ) {P}_{i} + β - {\tilde{b}}_{i} ]}^{2} = min \qquad ( 5 )$$

This results in N+2 equations:

$$\frac{1}{N} {\sum }_{i = 0}^{N - 1} [ {k}_{i} {P}_{i} + α - {\tilde{a}}_{i} ] = 0 \\ \frac{1}{N} {\sum }_{i = 0}^{N - 1} [ ( 1 - {k}_{i} ) {P}_{i} + β - {\tilde{b}}_{i} ] = 0 \\ \frac{1}{N} [ {k}_{n} {P}_{n} + α - {\tilde{a}}_{n} ] {k}_{n} + \frac{1}{N} [ ( 1 - {k}_{n} ) {P}_{n} + β - {\tilde{b}}_{n} ] ( 1 - {k}_{n} ) = 0 , \\ n = 0 … N - 1 \qquad ( 6 )$$

Extracting the two offsets from equation 6 gives:

$$α = \frac{1}{N} {\sum }_{i = 0}^{N - 1} {\tilde{a}}_{i} - \frac{1}{N} {\sum }_{i = 0}^{N - 1} {k}_{i} {P}_{i} \\ β = \frac{1}{N} {\sum }_{i = 0}^{N - 1} {\tilde{b}}_{i} - \frac{1}{N} {\sum }_{i = 0}^{N - 1} ( 1 - {k}_{i} ) {P}_{i} \\ {k}_{n}^{2} {P}_{n} + {( 1 - {k}_{n} )}^{2} {P}_{n} + ( α - {\tilde{a}}_{n} ) {k}_{n} + ( β - {\tilde{b}}_{n} ) ( 1 - {k}_{n} ) = 0 , \\ n = 0 … N - 1 \qquad ( 7 )$$

Substituting α and β into the equation 7, expanding, and multiplying by N gives:

$$N ( 2 {k}_{n}^{2} {P}_{n} - 2 {k}_{n} + 1 ) {P}_{n} - {k}_{n} {\sum }_{i = 0}^{N - 1} {k}_{i} {P}_{i} - ( 1 - {k}_{n} ) {\sum }_{i = 0}^{N - 1} ( 1 - {k}_{i} ) {P}_{i} == {Nk}_{n} {\tilde{a}}_{n} + N ( 1 - {k}_{n} ) {\tilde{b}}_{n} - {k}_{n} {\sum }_{i = 0}^{N - 1} {\tilde{a}}_{i} - ( 1 - {k}_{n} ) {\sum }_{i = 0}^{N - 1} {\tilde{b}}_{i} , \\ n = 0 … N - 1 \qquad ( 8 )$$

This can be shown to result in equation P=M⁻¹·R, where P are the unknown pixel values, M are the values corresponding to the geometry of the sensor, and R are values corresponding to the resulting signals. This can be written in matrix format as:

$$[ \begin{matrix}{P}_{0} \\ {P}_{1} \\ … \\ {P}_{N - 1}\end{matrix} ] = {⌊ \begin{matrix}( N - 1 ) ( 2 {k}_{0}^{2} - 2 {k}_{0} + 1 ) & - 2 {k}_{0} {k}_{1} + {k}_{0} + {k}_{1} - 1 & … & - 2 {k}_{N - 1} {k}_{0} + {k}_{0} + {k}_{N - 1} - 1 \\ - 2 {k}_{0} {k}_{1} + {k}_{0} + {k}_{1} - 1 & ( N - 1 ) ( 2 {k}_{1}^{2} - 2 {k}_{1} + 1 ) & … & - 2 {k}_{1} {k}_{N - 1} + {k}_{1} + {k}_{N - 1} - 1 \\ ⋮ & ⋮ & ⋱ & ⋮ \\ - 2 {k}_{N - 1} {k}_{0} + {k}_{0} + {k}_{N - 1} - 1 & - 2 {k}_{1} {k}_{N - 1} + {k}_{N - 1} - 1 & … & ( N - 1 ) ( 2 {k}_{N - 1}^{2} - 2 {k}_{N - 1} + 1 )\end{matrix} ⌋}^{- 1} [ \begin{matrix}{Nk}_{0} ( {\tilde{a}}_{0} - \overline{A} ) + N ( 1 - {k}_{0} ) ( {\tilde{b}}_{0} - \overline{B} ) \\ {Nk}_{1} ( {\tilde{a}}_{1} - \overline{A} ) + N ( 1 - {k}_{1} ) ( {\tilde{b}}_{1} - \overline{B} ) \\ … \\ {Nk}_{N - 1} ( {\tilde{a}}_{N - 1} - \overline{A} ) + N ( 1 - {k}_{N - 1} ) \cdot ( {\tilde{b}}_{N - 1} - \overline{B} )\end{matrix} ]$$

Where Ā, B̅ are the averages of the two resulting signal sets. In order to determine and compensate for row-to-row noise, then, the determination module 308 need only have access to a matrix that is the inverse of the final matrix given above. By multiplying the inverted matrix by a vector, which is a simple linear combination of the resulting signals, the corrected resulting signals (compensating for row-to-row noise) is produced. In one embodiment, the inverted matrix is stored, for example, in a flash memory or other storage component.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. A processing system for an input device, the processing system comprising:
a transmitter module comprising transmitter circuitry, the transmitter module coupled to a plurality of transmitter electrodes and configured to drive a first end of a first transmitter electrode of the plurality of transmitter electrodes to produce a first voltage gradient across the first transmitter electrode;
a receiver module, the receiver module configured to receive a plurality of resulting signals with a plurality of receiver electrodes, the plurality of resulting signals each comprising effects of the first voltage gradient; and
a determination module configured to determine a two-dimensional capacitive image based on the plurality of resulting signals, and wherein the determination module is further configured to determine positional information for a first input object located within a sensing region based on the capacitive image.

2. The processing system of claim 1, wherein the determination module is further configured to determine positional information for the first input object and a second input object within the sensing region based on the capacitive image.

3. The processing system of claim 1, wherein one of the plurality of resulting signals is substantially an interference-related resulting signal.

4. The processing system of claim 1, wherein the transmitter module is further configured to drive a second end of the first transmitter electrode to produce a second voltage gradient across the first transmitter electrode, and wherein the first voltage gradient is different than the second voltage gradient.

5. The processing system of claim 1, further comprising driving a second end of the first transmitter electrode, wherein the first end and second end are driven simultaneously.

6. The processing system of claim 1, wherein the plurality of receiver electrodes are arranged substantially perpendicular to the plurality of transmitter electrodes.

7. The processing system of claim 1, wherein the transmitter module is configured to drive a first end of a second transmitter electrode of the plurality of transmitter electrodes to produce a second voltage gradient across the second transmitter electrode; and wherein the receiver module is configured to receive a second plurality of resulting signals with the plurality of receiver electrodes, the second plurality of resulting signals each comprising effects of the second voltage gradient, and wherein the determination module is configured to determine the two-dimensional capacitive image further based on the second plurality of resulting signals.

8. An image gradient sensor device comprising:
a plurality of transmitter electrodes;
a plurality of receiver electrodes; and
a processing system communicatively coupled to the plurality of transmitter electrodes and the plurality of receiver electrodes, the processing system configured to:
drive a first end of a first transmitter electrode to produce a first voltage gradient across the first transmitter electrode;
receive a plurality of resulting signals with the plurality of receiver electrodes, the plurality of resulting signals each comprising effects of the first voltage gradient;
determine a two-dimensional capacitive image based on the plurality of resulting signals; and
determine positional information for a first input object located within a sensing region based on the capacitive image.

9. The image gradient sensor device of claim 8, wherein the processing system is further configured to determine positional information for the first input object and a second input object located substantially simultaneously within the sensing region.

10. The image gradient sensor device of claim 8, wherein one of the plurality of resulting signals is substantially an interference-related resulting signal.

11. The image gradient sensor device of claim 8, wherein the processing system is further configured to drive a second end of the first transmitter electrode to produce a second voltage gradient across the first transmitter electrode, and wherein the first voltage gradient is different than the second voltage gradient.

12. The image gradient sensor device of claim 8, further comprising driving a second end of the first transmitter electrode, wherein the first end and second end are driven simultaneously.

13. The image gradient sensor device of claim 8, wherein the plurality of receiver electrodes are arranged substantially perpendicular to the plurality of transmitter electrodes.

14. The image gradient sensor device of claim 8, wherein the plurality of transmitter electrodes are arranged substantially parallel to the plurality of receiver electrodes.

15. The image gradient sensor device of claim 8, wherein the plurality of transmitter electrodes and the plurality of receiver electrodes are disposed in a single layer on a common substrate.

16. A method of capacitive sensing, the method comprising:
driving a first end of a first transmitter electrode to produce a first voltage gradient across the first transmitter electrode;
receiving a plurality of resulting signals with a plurality of receiver electrodes to produce a two-dimensional capacitive image, the plurality of resulting signals each comprising effects of the first voltage gradient; and
determining positional information for a first input object located within a sensing region based on the capacitive image.

17. The method of claim 16, further comprising determining positional information for a second input object within the sensing region based on the capacitive image.

18. The method of claim 16, wherein receiving the plurality of signals includes receiving a first resulting signal that is substantially an interference-related resulting signal.

19. The method of claim 16, further comprising driving a second end of the first transmitter electrode to produce a second voltage gradient across the first transmitter electrode, and wherein the first voltage gradient is different than the second voltage gradient.

20. The method of claim 16, further comprising driving a second end of the first transmitter electrode, wherein the first end and second end are driven simultaneously.
